(19) United States
(12) Patent Application Publication
(10) Pub. No.: US 2008/0198840 A1
(43) Pub. Date: Aug. 21, 2008

(54) IP EXTENSION PHONE SYSTEM AND SERVER SYSTEM

(76) Inventors: HIROSHI KODAKA, Chigasaki (JP); Hiroyuki Kakiuchi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/857,484

(22) Filed: Sep. 19, 2007

(30) Foreign Application Priority Data
Jan. 26, 2007 (JP) 2007-016343

(51) Int. Cl. H04L 12/66

(52) U.S. Cl. 370/352

(57) ABSTRACT

There is provided an IP extension phone system including: a first server; a second server; and a portable IP phone, wherein when the second server detects connection of the portable IP phone, the second server assigns an IP address corresponding to the connected position to the portable IP phone, the portable IP phone registers the IP address in the first server, and the first server records an extension number and the IP address of the portable IP phone in an extension number management table and further records the extension number in a group management table while associating the extension number with a group corresponding to a segment of the IP address.

### CLAIM OF PRIORITY

The present application claims priority from Japanese patent application serial no. 2007-016343, filed on Jan. 26, 2007, the content of which is hereby incorporated by reference into this application.

### BACKGROUND OF THE INVENTION

The present invention relates to an IP extension phone system and a server system, and particularly to an IP extension phone system and a server system by which setting information can be dynamically changed.

PBX can provide various services to users of PBX. By forming a group on a department or division basis in business institutions where PBX is introduced, it is possible to maintain abbreviated dialing phone directories which are commonly used on a group basis and to answer the phone by call pickup.

Utilization of IP has been advanced even for PBX, and development of IPPBX that uses a main apparatus of PBX as a server and an IP telephony server is remarkable.

In the meantime, a concept of free address has been generated in Japan because offices in Japan are small in size as compared to office environments in Europe and the United States. In the concept of free address, the number of desks to be placed in an office is determined on the basis of the number of employees who use the desks, not the number of all employees, and desk space per person in the ratio of the number of all employees to the number of employees who use the desks can be made larger. Of course, there is no desk which is fixedly assigned to each employee, and thus an employee who needs to use a desk uses an arbitrary desk. On the contrary, the free address is advantageous in efficiency of management because more employees can be assigned in the same floor area.

In addition, thin clients are widely used under the environment of tighter information management of recent years. A thin client system is a system in which a blade server having plural servers integrated is installed in a server room and a user accesses the blade server from a client which is not equipped with a hard disk drive and narrows down the functions. Specifically, since information is stored only in the blade server, risks of information leaks are few. A client is generally a portable PC, and has high affinity with the above-described free address. More specifically, a user of a client appropriately selects a desk and just connects the client to a switch provided on the desk, so that the desktop environment for the user can be established.

Japanese Patent Application Laid-Open No. 2006-254411 discloses means for realizing a softphone in a thin client system.

However, services of PBX have generally low affinity with the free address. This is because phone numbers are associated with telephones on a one-to-one basis, and thus the phone number of a telephone which receives a call is unknown in the free address. In Japanese Patent Application No. 2006-14222 (applied on May 23, 2006) which is the previous application of the inventors and has not been published at this time, there is described an invention in which an IP phone is provided with means for reading phone number information of the IP phone itself and means for notifying a PC of the phone number information read via a network, and the PC is provided with means for receiving the notification from the IP phone.

In recent years, plural wireless LAN access points are provided in extension phone systems in companies, and softphones of PCs are utilized as extension terminals. In addition, there is also a case that companies distribute to their employees wireless LAN-compatible cellular phone terminals which can be connected to two networks of a portable phone network and a wireless LAN. The employees connect the cellular phone terminals to the wireless LAN access points for use as extension phone terminals in the office. In addition, the employees connect the cellular phone terminals to base stations of the cellular phone network for use as general cellular phone terminals outside the office.

A call pickup as one of functions of PBX under the free address environment will be described with reference to FIG. 1 and Table 1. FIG. 1 is a diagram for schematically explaining a desk layout in an office. Further, Table 1 is a call pickup group table. In FIG. 1, a section composed of desks 10-11 to 10-16 and a section composed of desks 10-21 to 10-26 are laid out in the office under the free address environment. Extension phone terminals 20A-31, 32, and 33 in the section composed of the desks 10-11 to 10-16 form a call pickup group 1, and extension phone terminals 20A-41, 42, and 43 in the section composed of the desks 10-21 to 10-26 form a call pickup group 2. PBX (not shown) holds a call pickup group table shown in Table 1. The call pickup group table is set by a maintenance person of PBX. The xy of the extension phone terminal 20-xy indicates the extension number of the terminal.

TABLE 1
Call Pickup Group Table

| Group ID | Extension Phone Number |
|---|---|
| 1 | 31, 32, 33 |
| 2 | 41, 42, 43 |
| 3 | |

The call pickup is a function by which when an incoming call rings at the extension phone terminal 20A-41 on a vacant desk, PBX that detected, for example, inputting of “11” which is a special number for call pickup from the extension phone terminal 20A-43 in the same call pickup group switches the incoming call so as to be connected to the extension phone terminal 20A-43.

However, in the case where a PC having a softphone installed is brought in the section under the free address environment, it is impossible to perform a call pickup by use of the softphone because the PC having the softphone installed has not been registered in the call pickup group of the section.

As similar thereto, it is impossible to perform a call pickup by use of a wireless LAN portable terminal. The cause of these problems is that the call pickup group table of PBX is fixed.

The present invention provides an IP phone system and a server system capable of including even a softphone or a wireless LAN-compatible portable terminal in a call pickup group.

### SUMMARY OF THE INVENTION

The above-described object can be achieved by an IP extension phone system including: a first server; a second server; and a portable IP phone, wherein when the second server detects connection of the portable IP phone, the second server assigns an IP address corresponding to the connected position to the portable IP phone, the portable IP phone registers the IP address in the first server, and the first server records an extension number and the IP address of the portable IP phone in an extension number management table and further records the extension number in a group management table while associating the extension number with a group corresponding to a segment of the IP address.

Further, the above-described object can be achieved by a server system that controls a call of an IP extension phone system, wherein on the basis of position information of an IP phone which is newly connected, the IP phone is registered in one of call pickup groups.

### BRIEF DESCRIPTION OF THE DRAWINGS

Preferred embodiments of the present invention will now be described in conjunction with the accompanying drawings, in which;

FIG. 1 is a diagram for schematically explaining a desk layout in an office;

FIG. 2 is a block diagram of an extension phone system;

FIG. 3 is a functional block diagram of an IPT server;

FIG. 4 is a hardware block diagram of the IPT server;

FIG. 5 is a diagram for explaining a group management table;

FIG. 6 is a diagram for explaining an extension number management table;

FIG. 7 is a diagram for schematically explaining a desk layout in an office;

FIG. 8 is a diagram for explaining a state in which a portable PC is brought in under the free-access-address environment;

FIG. 9 is a sequence diagram for explaining a process performed among the PC, a DHCP server, and the IPT server;

FIG. 10 is a flowchart for explaining a process performed by the IPT server;

FIG. 11 is a diagram for explaining a state in which the portable PC is moved under the free-access-address environment; and

FIG. 12 is a diagram for explaining a state in which a wireless LAN portable terminal is moved to a range controlled by a different access point under the wireless LAN environment.

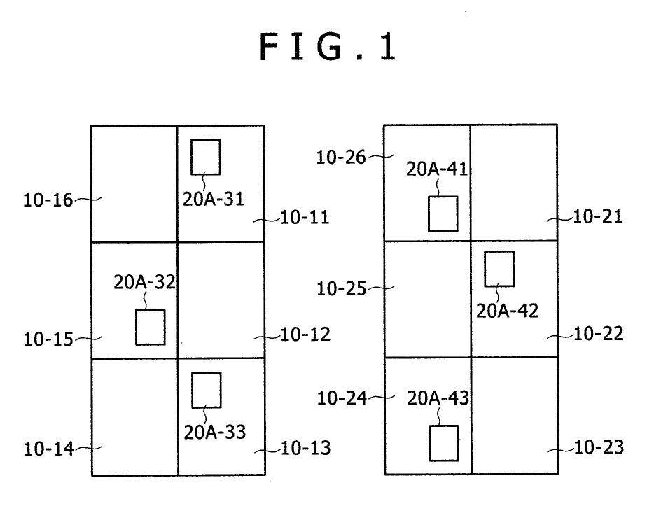

### DETAILED DESCRIPTION OF THE PREFERRED EMBODIMENTS

Hereinafter, embodiments of the present invention will be described with reference to the drawings. It should be noted that the identical units are given the same reference numerals in the following description, and thus the explanations thereof will not be repeated.

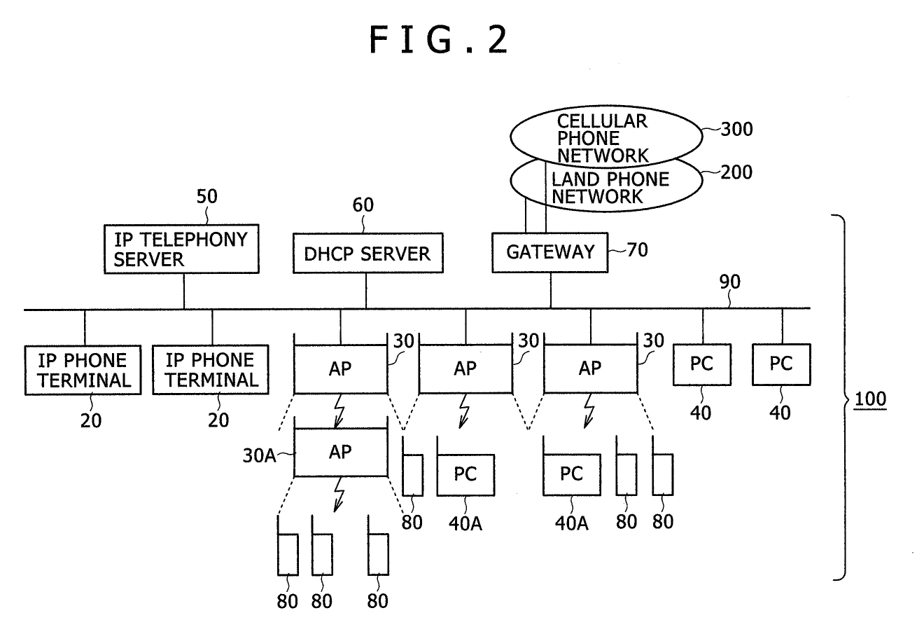

With reference to FIG. 2, an extension phone system will be described. FIG. 2 is a block diagram of the extension phone system.

In FIG. 2, an extension phone system 100 includes an IP telephony server (hereinafter, referred to as an IPT server) 50, a DHCP (Dynamic Host Configuration Protocol) server 60, a gateway 70, IP phone terminals 20, access points (APs) 30, PCs 40, and wireless LAN portable terminals 80, all of which are connected to a company's IP network 90. It should be noted that the PCs 40 and APs 30 are connected to the company's IP network 90 by wire, and PCs 40A and an AP 30A are wirelessly connected to the APs 30. The gateway 70 is connected to a land phone network 200 and a cellular phone network 300.

The IPT server 50 is an SIP server, and controls a call between internal lines and between internal and external lines. When receiving a request of an IP address from a client, the DHCP server 60 transmits the IP address corresponding to a sub-network on the receiver side, and enables the client to use the network in a plug-and-play manner. The gateway 70 allows the company's IP network 90 to be connected to the land phone network 200 and the cellular phone network 300. The APs 30 allow the AP 30A, PCs 40A, and wireless LAN portable terminals 80 to be connected to the company's IP network 90. The PCs 40 and 40A are operated as phone terminals by utilizing headsets and by executing a softphone program.

The number of DHCP servers 60 is not limited to one for each network, and the DHCP servers 60 may be arranged at terminal switches in a distributed manner. Further, the DHCP servers 60 may be incorporated in the access points for distributed arrangement.

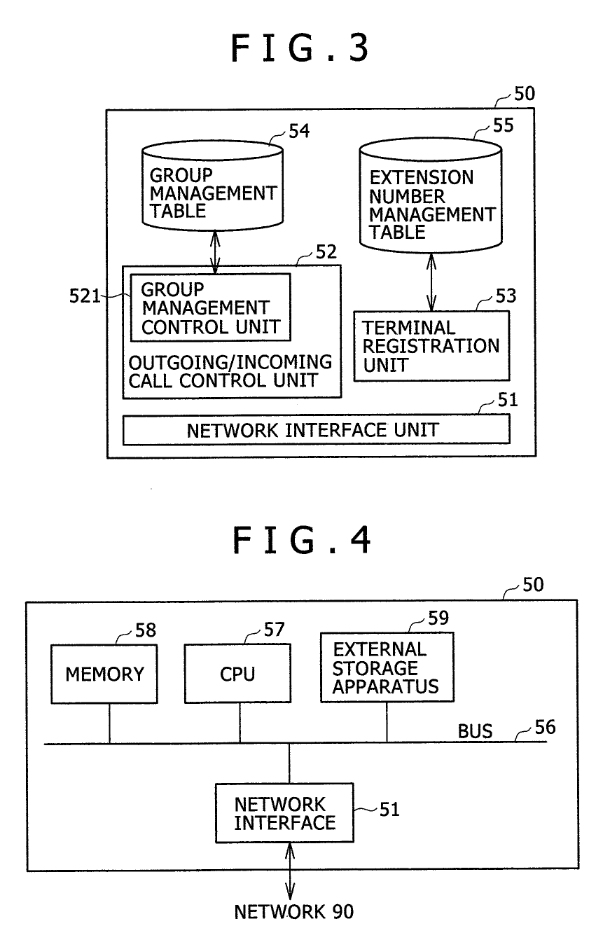

With reference to FIGS. 3 and 4, the IPT server will be described. FIG. 3 is a functional block diagram of the IPT server. FIG. 4 is a hardware block diagram of the IPT server.

In FIG. 3, the IPT server 50 includes a network interface unit 51, an outgoing/incoming call control unit 52, a terminal registration unit 53, a group management table (section) 54, and an extension number management table (section) 55.

The network interface unit 51 allows the company's IP network 90 to be connected to the IPT server 50. The outgoing/incoming call control unit 52 further includes a group management control unit 521, and controls each call. The terminal registration unit 53 manages connection or disconnection of the extension phones (IP phone terminals, PCs, and wireless LAN portable terminals). The terminal registration unit 53 also manages the extension number management table (section) 55. The group management control unit 521 manages the group management table (section) 54.

In FIG. 4, the IPT server 50 includes a CPU 57, a memory 58, an external storage apparatus 59, and a network interface 51, all of which are connected to a bus 56. As apparent from comparison between FIGS. 3 and 4, the outgoing/incoming call control unit 52 and the terminal registration unit 53 of the IPT server 50 are realized by a program which is stored in the external storage apparatus 59, and the CPU 57 executes the program written in the memory 58 from the external storage apparatus 59.

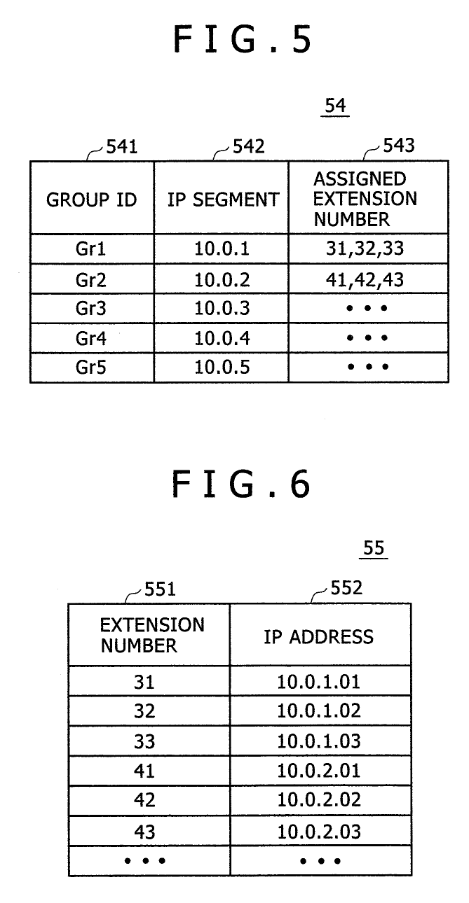

With reference to FIGS. 5 and 6, the group management table and the extension number management table will be described. FIG. 5 is a diagram for explaining the group management table. FIG. 6 is a diagram for explaining the extension number management table.

In FIG. 5, the group management table 54 includes a group ID 541, an IP segment 542, and an assigned extension number 543. As apparent from FIG. 5, the group ID 541 is associated with the IP segment 542 on a one-to-one basis in the group management table 54. When an incoming call rings at extension number 31 in Gr 1 and the outgoing/incoming call control unit 52 of the IPT server 50 receives a special number “11” from extension number 32 or 33 in Gr 1, the outgoing/incoming call control unit 52 switches the incoming call so as to be connected to extension number 32 or 33 for call pickup. It should be noted that last two digits (in the case of a decimal base expression) of an IP address may be used for the assigned extension number 543. On the contrary, the group management table 54 may be composed only of the assigned extension number 543 without using the group ID 541 and the IP segment 542.

An extension number 551 is associated with an IP address 552 in the extension number management table 55 in FIG. 6. The terminal registration unit 53 of the IPT server 50 manages connection or disconnection of the extension phones (IP phone terminals, PCs, and wireless LAN portable terminals) by updating the extension number management table 55.

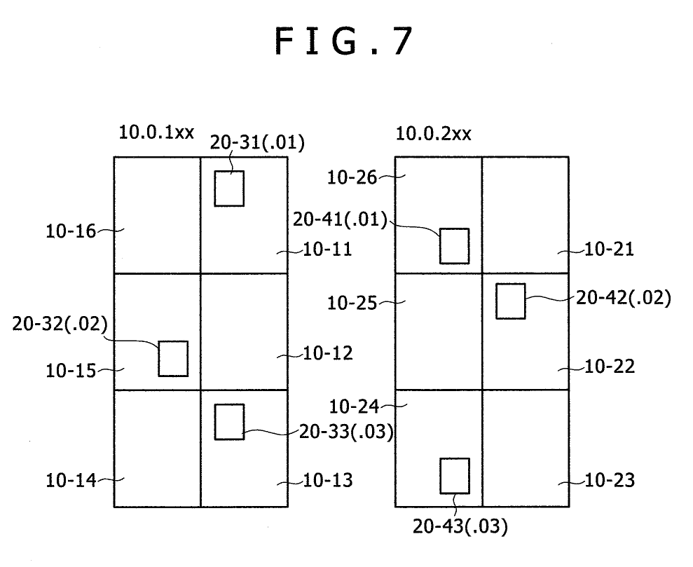

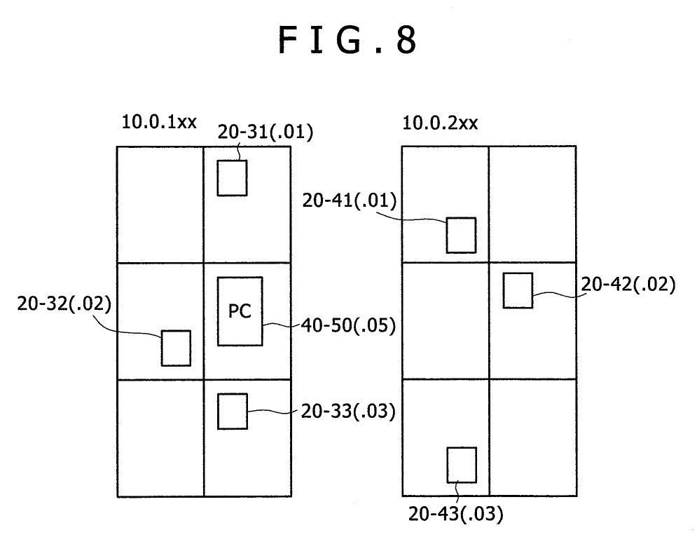

With reference to FIGS. 7 and 8, the call pickup in the IP phone system under the free address environment will be described. FIG. 7 is a diagram for schematically explaining a desk layout in an office. FIG. 8 is a diagram for explaining a state in which a portable PC incorporating a softphone is brought in under the free-access-address environment.

In FIG. 7, a segment of 10.0.1 of an IP address is assigned to a section composed of desks 10-11 to 10-16, and a segment of 10.0.2 of the IP address is assigned to a section composed of desks 10-21 to 10-26. IP phone terminals 20-31 to 20-33 and 20-41 to 20-43 are arranged in the section composed of the desks 10-11 to 10-16 and the section composed of the desks 10-21 to 10-26, respectively. The xx and yy of the IP phone terminal 20-xx (yy) indicate an extension number of the phone terminal and an address of the phone terminal that follows the segment of the IP address, respectively. As an example, the extension number of the IP phone terminal 20-31 (0.01) is 31, and the IP address thereof is 10.0.1.01.

There will be explained a case where a portable PC is brought in under the environment of FIG. 7. In FIG. 8, when a user of a PC 40-50 connects the PC 40-50 to a LAN cable to start the same, an IP address 10.0.1.05 is assigned to the PC 40-50. When the user of the PC 40-50 starts the softphone, the PC 40-50 can be used as an phone terminal.

A record of Gr 1 in the group management table 54 that was explained using FIG. 5 is represented as follows.

Gr 1 10.0.1 31, 32, 33, 50

Thus, an incoming call to the IP phone terminal 20-31 can be received by call pickup using the PC 40-50.

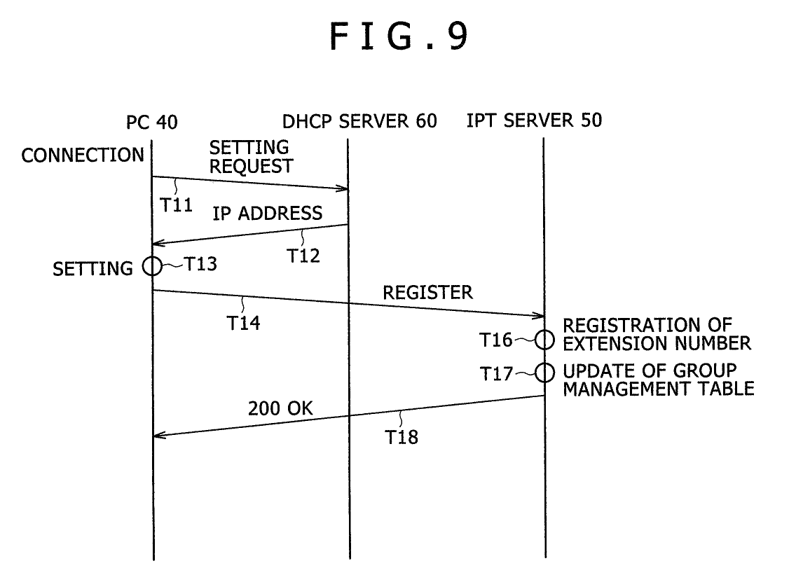

With reference to FIG. 9, there will be explained a process performed among the PCs, DHCP server, and IPT server (T1). FIG. 9 is a sequence diagram for explaining a process performed among the PCs, DHCP server, and IPT server.

In FIG. 9, when the PC 40 is connected to a network to be started, the PC 40 requests the DHCP server 60 to transmit setting information required for network connection (T11). The DHCP server 60 sends back the setting information required for network connection including the IP address of the PC 40, to the PC 40 (T12). The PC 40 reflects the notified setting information on itself (T13). Next, the PC 40 transmits a REGISTER message to the IPT server 50 (T14). The REGISTER message includes the IP address of the PC 40. The IPT server 50 records the extension number and the IP address into the extension number management table 55 (T16). The IPT server 50 also updates the group management table 54 (T17). The IPT server 50 transmits “200 OK” to the PC 40 (T18). Then, a series of the process is completed.

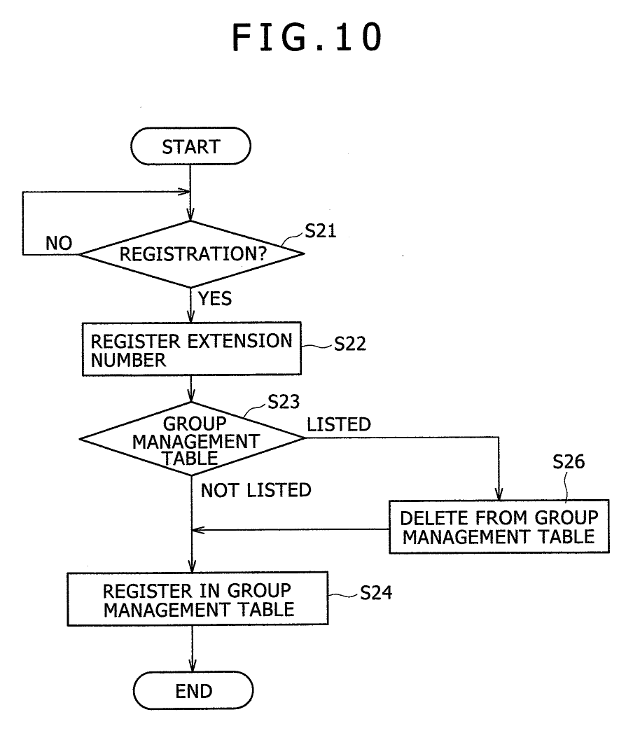

With reference to FIG. 10, a process performed by the IPT server will be described. FIG. 10 is a flowchart for explaining a process performed by the IPT server.

The IPT server 50 monitors the registration of an extension number (S21). If the registration is to be conducted, the IPT server 50 registers the extension number and the IP address. In addition, the IPT server 50 determines whether an appropriate extension number is listed in the group management table. If an appropriate extension number is not listed in the group management table (S23: Not listed), the IPT server 50 registers the extension number in the group management table (S24), and then the process is completed. If an appropriate extension number is listed in the group management table in Step 23, the IPT server 50 deletes the extension number from the group management table (S26), and then the process proceeds to Step 24.

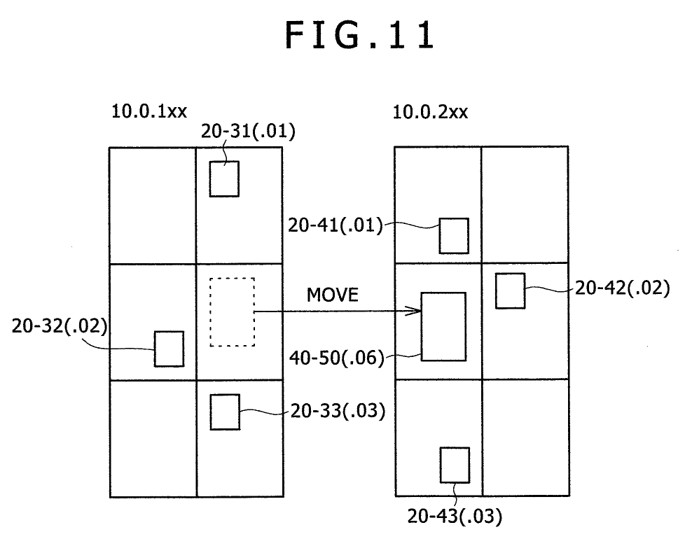

With reference to FIG. 11, there will be described moving of the PC incorporating the softphone under the free address environment. FIG. 11 is a diagram for explaining a state in which the portable PC incorporating the softphone is moved under the free-access-address environment.

In FIG. 11, when the user of the PC 40-50 is moved to the section with a segment of 10.0.2 from the section with a segment of 10.0.1, the DHCP server 60 first detects the linkdown of the PC 40-50 and releases the IP address 10.0.1.5. The DHCP server 60 receives a setting request from the PC 40-50 that moved to the section with a segment of 10.0.2, and assigns an IP address 10.0.2.6. When the user of the PC 40-50 starts the softphone, the IPT server 50 registers the corresponding address of extension number 50 in the extension number management table 55, as IP address 10.0.2.6. The IPT server 50 deletes extension number 50 from Gr 1 in the group management table 54, and registers the same in Gr 2. Accordingly, records of Gr 1 and Gr 2 in the group management table 54 are changed and represented as follows.

Gr 1 10.0.1 31, 32, 33

Gr 2 10.0.2 41, 42, 43, 50

Thus, an incoming call to the IP phone terminal 20-41 can be received by call pickup using the PC 40-50.

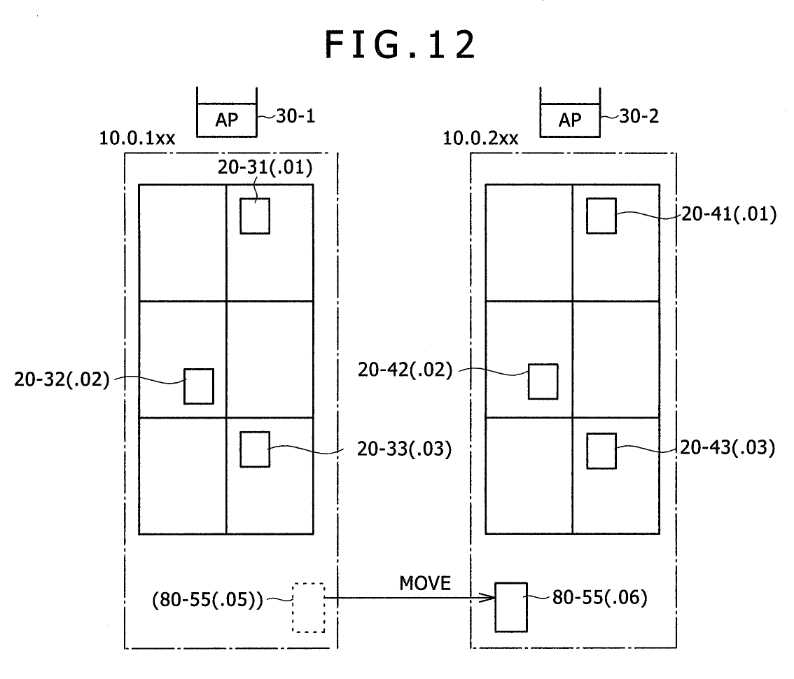

With reference to FIG. 12, another embodiment will be described. FIG. 12 is a diagram for explaining a state in which a wireless LAN portable terminal is moved to a range controlled by a different access point under the wireless LAN environment.

In FIG. 12, APs 30-1 and 30-2 cover the PC 40A and the wireless LAN portable terminal 80 located in ranges represented by dashed lines. The IP phone terminals 20 placed on the desks are not directly connected to the APs 30. However, by associating a section composed of desks with a range covered by the AP 30, the IP phone terminals 20 and the wireless LAN portable terminal 80 make a call pickup group. In this case, it is not necessary that the IP segment of the IP phone terminals 20 corresponds to that of the wireless LAN portable terminal 80. However, the following description is a case where the IP segment of the IP phone terminals 20 corresponds to that of the wireless LAN portable terminal 80.

When a user of a wireless LAN portable terminal 80-55 is moved to the vicinity of the section with a segment of 10.0.2 from the vicinity of the section with a segment of 10.0.1, an access point for covering the wireless LAN portable terminal 80-55 is handed over from the AP 30-1 to the AP 30-2. The DHCP server 60 first detects the linkdown of the wireless LAN portable terminal 80-55 in the AP 30-1 and releases the IP address 10.0.1.5. The DHCP server 60 receives a setting request from the AP 30-2 that detected the wireless LAN portable terminal 80-55 moved to the section with a segment of 10.0.2, and assigns an IP address 10.0.2.6. Since the access point is changed from the AP 30-1 to the AP 30-2, the IPT server 60 registers the corresponding address of extension number 55 in the extension number management table 55, as IP address 10.0.2.6. The IPT server 60 also deletes extension number 55 from Gr 1 of the group management table 54, and registers the same in Gr 2. Accordingly, records of Gr 1 and Gr 2 in the group management table 54 are changed and represented as follows.

Gr 1 10.0.1 31, 32, 33

Gr 2 10.0.2 41, 42, 43, 55

Thus, an incoming call to the IP phone terminal 20-41 can be received by call pickup using the wireless. LAN portable terminal 80-55.

According to the above described embodiments, provision of means for dynamically changing a call pickup group in the IPT server allows a portable communication apparatus to belong to a call pickup group.

According to the present embodiments, a portable communication apparatus can be allowed to belong to a call pickup group.

What is claimed is:

1. An IP extension phone system comprising:
a first server;
a second server; and
a portable IP phone,
wherein when said second server detects connection of the portable IP phone, said second server assigns an IP address corresponding to the connected position to the portable IP phone, said portable IP phone registers the IP address in the first server, and said first server records an extension number and the IP address of the portable IP phone in an extension number management section and further records the extension number in a group management section while associating the extension number with a group corresponding to a segment of the IP address.

2. A server system that controls a call of an IP extension phone system,
wherein on the basis of position information of an IP phone which is newly connected, said IP phone is registered in one of call pickup groups.

3. The server system according to claim 2,
wherein said position information is an IP address of the IP phone.

4. The server system according to claim 2,
wherein said position information is an access point covering the IP phone.

5. The server system according to claim 2, including an extension number management section in which extension numbers of the IP phones are associated with the IP addresses, and a group management section in which the IP phones are classified into groups.

6. The server system according to claim 3, including an extension number management section in which extension numbers of the IP phones are associated with the IP addresses, and a group management section in which the IP phones are classified into groups.

7. The server system according to claim 4, including an extension number management section in which extension numbers of the IP phones are associated with the IP addresses, and a group management section in which the IP phones are classified into groups.
